(19) United States
(12) Patent Application Publication
(10) Pub. No.: US 2011/0036945 A1
(43) Pub. Date: Feb. 17, 2011

(54) FRONT AIRCRAFT LANDING GEAR BUILT INTO ELECTRIC CONTROL

(75) Inventor: Didier Reynes, Toulouse (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: AIRBUS OPERATIONS (INC. AS A SOC.PAR ACT. SIMPL.), TOULOUSE (FR)

(21) Appl. No.: 12/989,911

(22) PCT Filed: May 28, 2009
(86) PCT No.: PCT/FR09/50993

§ 371 Date: Oct. 27, 2010

(30) Foreign Application Priority Data
May 29, 2008 (FR) 0853523

(51) Int. Cl. B64C 25/10; B64C 25/26

(52) U.S. Cl. 244/102 SL

(57) ABSTRACT

A front aircraft landing gear built into an electric control including: a landing gear leg to be pivotably mounted on a structure of the aircraft between a retracted position and an extended position; an actuating cylinder moving the landing gear leg from the retracted position to the extended position; a strut that maintains the landing gear leg in the extended position thereof; an uplock housing that maintains the landing gear leg in the retracted position thereof; an uplock housing an operating mode control and a backup mode for the same housing; and four stress-adding points adding stress to the aircraft structure, namely two points for the pivotal movement of the landing gear leg and two points for the pivotal movement of the strut.

### TECHNICAL FIELD

The invention concerns a front aircraft landing gear comprising:

a landing gear leg able to be pivotably mounted on a structure of the aircraft between a retracted position and an extended position;

an actuating cylinder moving the landing gear leg from the retracted position to the extended position and vice versa,

a strut that maintains the landing gear leg in the extended position thereof;

an uplock housing that maintains the landing gear leg in the retracted position thereof;

an uplock housing normal operating mode control;

a backup mode for the same housing.

A retractable front aircraft landing gear is generally made up of the following main elements:

a landing gear leg that includes the vibration damper and the wheels;

a strut that serves to keep the landing gear leg in its deployed position when the landing gear is in the extended position;

an actuating cylinder that ensures the maneuvers of the landing gear train, i.e. retraction and extension of the landing gear;

an uplock housing making it possible to maintain the landing gear in the retracted position when it must be stored in its housing outside the takeoff, landing, and taxi phases of the apparatus.

The uplock housing is equipped with two control systems, one for the normal operating mode and the other for the backup operating mode. The control is generally hydraulic for the normal operating mode and mechanical for the backup mode.

In order to facilitate the connections with these control systems, the uplock housing is installed, according to the prior art, on the structure of the apparatus. Indeed, if the housing were integrated on an element of the landing gear, these controls, particularly the mechanical control, would have to follow the movements of the element of the concerned landing gear. This would complicate the design and installation and increase the mass thereof.

The installation of front landing gear in the structure of an aircraft is therefore done through a large number of interface points, for example six. These interface points represent as many stress-adding points. These stress--adding points require reinforcements of the structure of the aircraft and translate to an additional mass associated with said structure. Moreover, the interface points translate to points to be defined between the manufacturer of the landing gear and that of the structure of the apparatus as well as the volume of the parts to be managed, since certain points are very close to each other. Lastly, the interface points translate to as many connections to be made during assembly or disassembly of the landing gear.

These problems are resolved, according to the invention, by the fact that the landing gear includes four stress-adding points with the structure of the aircraft, i.e. two points for pivoting of the landing gear leg on the structure of the aircraft and two points for pivoting of the strut on the structure of the aircraft.

Owing to these features, the interface points of the landing gear with the structure of the apparatus are minimized. Consequently, mass is saved by reducing the number of stress-adding points with the structure of the apparatus, while simplifying the connections with the control system, which globally results in a simplification of the landing gear installation in said structure.

Advantageously, the actuating cylinder is fastened, at one of its ends, on the landing gear leg, and at its other end, on the strut.

Advantageously, the uplock housing is mounted on the strut.

In one preferred embodiment, the backup mode control of the uplock housing is electric.

In another embodiment, the backup mode control of the uplock housing is hydraulic.

The normal operating mode control of the uplock housing can be hydraulic or electric. Likewise, the actuating cylinder of the landing gear leg can be hydraulic or electric.

Other features and advantages of the invention will appear upon reading the following description of an embodiment, provided for information in reference to the appended figures. In these figures:

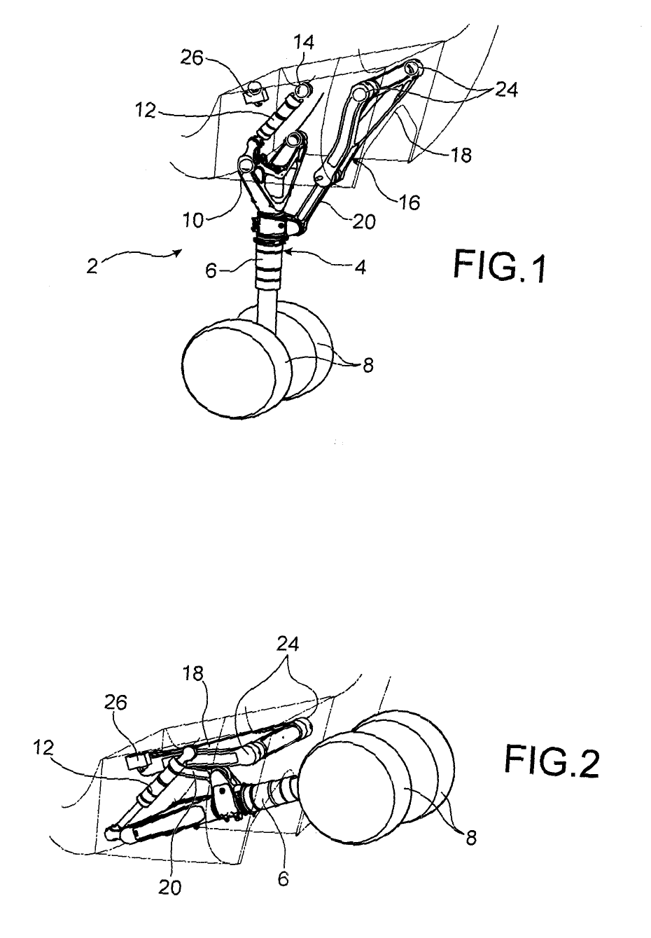

FIG. 1 shows landing gear according to the prior art in the deployed position;

FIG. 2 shows a view of the landing gear of the prior art in the retracted position;

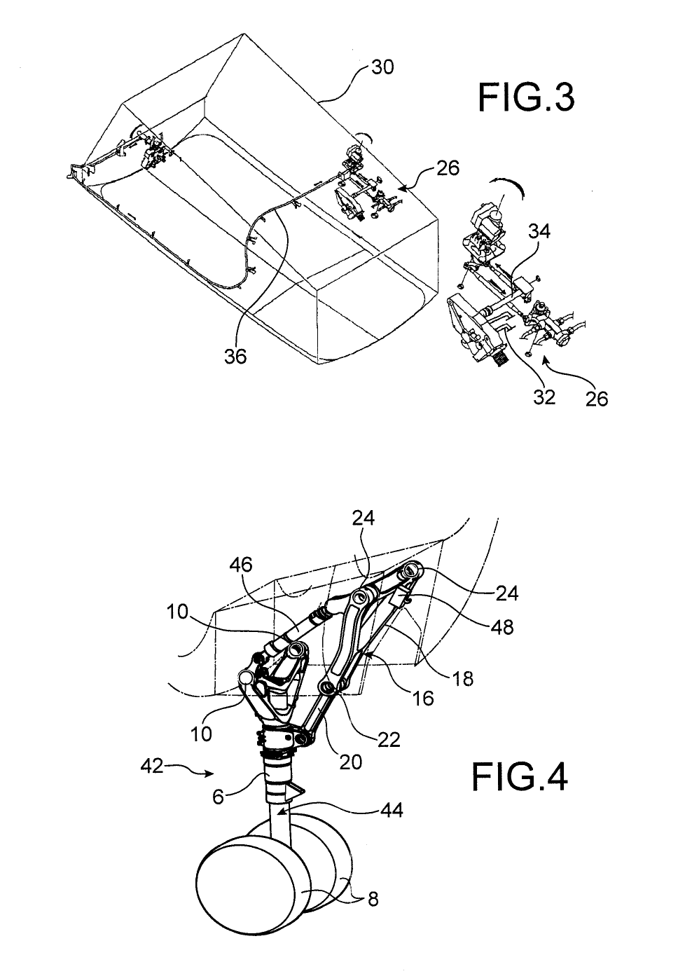

FIG. 3 shows a diagrammatic view of an uplock housing according to the prior art;

FIG. 4 shows landing gear according to the present invention in the deployed position;

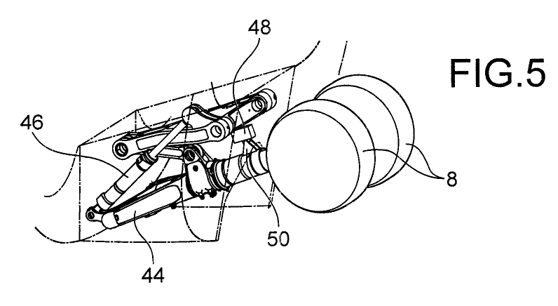

FIG. 5 shows the landing gear of FIG. 4 in the retracted position.

FIG. 1 shows landing gear, designated by the general reference 2, according to the prior art in the extended position thereof. This landing gear first includes a landing gear leg 4, including a vibration damper 6 and two wheels 8.

The landing gear leg is pivotably mounted on the aircraft structure around two fastening points 10. A cylinder 12 mounted at one end of the landing gear leg and at another end at a fastening point 14 on the aircraft structure makes it possible to move the landing gear leg from the extended position shown in FIG. 1 to the retracted position shown in FIG. 2 and vice versa.

The landing gear also includes a strut 16. This strut is formed by a triangular structure 18 and a bar 20 mounted at one end on the triangular structure and at its other end on the landing gear leg. The bar 20 and the triangular structure 18 are pivotably mounted around an axis 22. The triangular structure 18 is pivotably mounted on the aircraft structure around two fastening points 24.

Lastly, the landing gear includes an uplock housing 26 making it possible to maintain the landing gear in the retracted position when it must be stored in its housing outside the takeoff, landing, and taxi phases of the apparatus.

FIG. 2 shows the landing gear of FIG. 1 in the retracted position. In this figure, the cylinder 12 has a maximum length so as to cause the wheels 8 to raise up inside a housing formed in the aircraft structure. The triangular structure 18 and the bar 20 are folded on each other. One end of the triangular structure 18 is connected to the uplock housing 26.

FIG. 3 shows a view of the housing of the landing gear equipped with an uplock housing 26. Out of a concern for simplification, the landing gear is not shown in this figure. The uplock housing, according to the prior art, includes a hydraulic control 32 for the normal operating mode and a mechanical control 34 for the backup operating mode. The mechanical control is for example actuated by a torque shaft controlled by a rod that is itself controlled by an actuator controlled from the control cabin of the aircraft. As seen, the uplock housing 26 is installed on the structure of the apparatus, i.e. one of the faces of the housing 30. Indeed, if the control housing 26 were installed on an element of the landing gear, these mechanical controls would have to follow the movements of that element during the retraction and extension of the landing gear, which would result in major complication of the system as well as an increase in the mass thereof.

FIG. 4 shows landing gear according to the present invention in the deployed position. This includes, like the landing gear of the prior art, a vibration damper 6 and two wheels 8. It is pivotably mounted around a fastening point 10 on the aircraft structure. A cylinder 46 makes it possible to move the landing gear leg 44 from the extended position that it occupies in FIG. 4 to the retracted position it occupies in FIG. 5. The cylinder is fastened, at one of its ends, to the landing gear leg 44 and, at its other end, to the triangular structure 18. In this way, the hinge point, referenced 14 in FIG. 1, of the cylinder 12 on the aircraft structure is eliminated. The uplock housing 48 is also fastened on the triangular structure 18. The fastening point referenced 26 in FIG. 1 of the uplock housing on the structure of the apparatus is thereby eliminated.

FIG. 5 shows the landing gear of FIG. 4 in the retracted position. In this figure, the cylinder 46 is in the maximum deployed position so as to cause the wheels 8 to raise up into the housing 30 provided in the structure of the apparatus. The landing gear leg 44 is connected at 50 to the uplock housing 48 fastened on the triangular structure 18.

It is noted that the landing gear shown in FIGS. 4 and 5 makes it possible to minimize the interfaces with the structure of the apparatus and therefore to reduce the stress-adding points with said structure, which makes it possible to arrive at an overall solution that is lighter and simpler.

For this to be easily manageable, according to the invention, the backup mode of the uplock housing is preferably electric or possibly hydraulic. Likewise, the actuating cylinder 46 can be hydraulic or electric. The normal operating mode of the uplock housing can also be hydraulic or electric. All possible combinations of hydraulic or electric actuating are possible.

The most optimal configuration is that in which the normal operating mode of the uplock housing, the backup mode of the uplock housing and the actuating cylinder operate electrically. Indeed, there is then only one connection type between the landing gear and the structure of the apparatus. This connection is more flexible to define and install than a connection of the hydraulic or possibly mechanical type. Moreover, for the removal or refitting of the actuating cylinder, there is no intervention on the hydraulic circuit of the apparatus such as purging the circuit to eliminate the air that may be present in the circuit as well as leveling the liquid.

1-7. (canceled)

8. A front aircraft landing gear comprising:
a landing gear leg configured to be pivotably mounted on a structure of the aircraft between a retracted position and an extended position;
an actuating cylinder moving the landing gear leg from the retracted position to the extended position and vice versa;
a strut that maintains the landing gear leg in the extended position thereof;
an uplock housing that catches the landing gear leg and maintains it in the retracted position thereof;
an uplock housing a normal operating mode control;
an uplock housing a backup operating mode control; and
four stress-adding points for adding stress to the aircraft structure, including two points for pivotal movement of the landing gear leg on the aircraft structure and two points for pivotal movement of the strut on the aircraft structure.

9. The landing gear according to claim 8, wherein the actuating cylinder is fastened, at one of its ends, on the landing gear leg, and at its other end on the strut.

10. The landing gear according to claim 8, wherein the uplock housing is mounted on the strut.

11. The landing gear according to claim 9, wherein the uplock housing is mounted on the strut.

12. The landing gear according to claim 8, wherein the uplock housing backup control is electric.

13. The landing gear according to claim 9, wherein the uplock housing backup control is electric.

14. The landing gear according to claim 8, wherein the uplock housing backup control is hydraulic.

15. The landing gear according to claim 9, wherein the uplock housing backup control is hydraulic.

16. The landing gear according to claim 8, wherein the uplock housing normal operating control is hydraulic or electric.

17. The landing gear according to claim 9, wherein the uplock housing normal operating control is hydraulic or electric.

18. The landing gear according to claim 8, wherein the actuating cylinder of the landing gear is hydraulic or electric.

19. The landing gear according to claim 9, wherein the actuating cylinder of the landing gear is hydraulic or electric.
